(19) United States
(12) Patent Application Publication
(10) Pub. No.: US 2015/0294535 A1
(43) Pub. Date: Oct. 15, 2015

(54) System that Allows Players to Use their Skill to Gain a Mathematical Advantage in a Game of Chance

(71) Applicant: NanoTech Entertainment, Inc., San Jose, CA (US)

(72) Inventors: Aaron Hightower, Las Vegas, NV (US); Stephen Riesenberger, Henderson, NV (US)

(73) Assignee: NanoTech Entertainment, Inc.

(21) Appl. No.: 14/681,998

(22) Filed: Apr. 8, 2015

Related U.S. Application Data
(60) Provisional application No. 61/977,250, filed on Apr. 9, 2014.

(51) Int. Cl. G07F 17/32

(52) U.S. Cl. CPC G07F 17/3262; G07F 17/3244

(57) ABSTRACT

A system and method of gambling that gives a player a skill-based challenge for an opportunity to gain a mathematical advantage in a game of chance. The method comprises providing a combination game of skill and a game of chance, where the game of chance is resolved after the game of skill and the game of skill provides an opportunity to attain a mathematical advantage in the game of chance.

### CROSS-REFERENCE TO RELATED APPLICATION

This patent application claims the benefit of U.S. Provisional Patent Application Ser. No. 61/977,250, entitled “System That Allows Players to Use Their Skill to Gain a Mathematical Advantage in a Game of Chance,” filed Apr. 9, 2014, which application is incorporated in its entirety here by this reference.

### TECHNICAL FIELD

This invention relates to games of chance. More specifically, this invention relates to altering the probability of winning a game of chance using a skill-based game.

### BACKGROUND

Casino machines typically have a fixed set of payouts that always give the house a statistical advantage over the player. There is an absence of games that engage a player to use skill to alter the probability of winning so that the player can obtain a mathematical advantage in individual games over the house.

For the foregoing reasons there is a need for a system that provides players an opportunity to increase or decrease their probability of winning in a game of chance by altering the probability of winning based on a player's performance in a game of skill.

### SUMMARY

The present invention is directed to a system and method of playing a game of chance that gives a player a skill-based challenge for an opportunity to gain a mathematical advantage in the game of chance. The method comprises providing a combination game of skill and a game of chance, where the game of chance is resolved after the game of skill and the game of skill provides an opportunity to attain a mathematical advantage in the game of chance.

### BRIEF DESCRIPTION OF DRAWINGS

FIG. 1A shows a pinball machine used as a game of skill in accordance with an embodiment of the present disclosure.

FIG. 1B shows a set up phase in accordance with an embodiment of the present disclosure.

FIG. 1C shows a set up phase in accordance with an embodiment of the present disclosure.

FIG. 2 shows an exemplary flow diagram of a process in accordance with an embodiment of the present disclosure.

FIG. 3 shows a high-level diagram of a computer that may be used to implement various aspects of the present invention.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

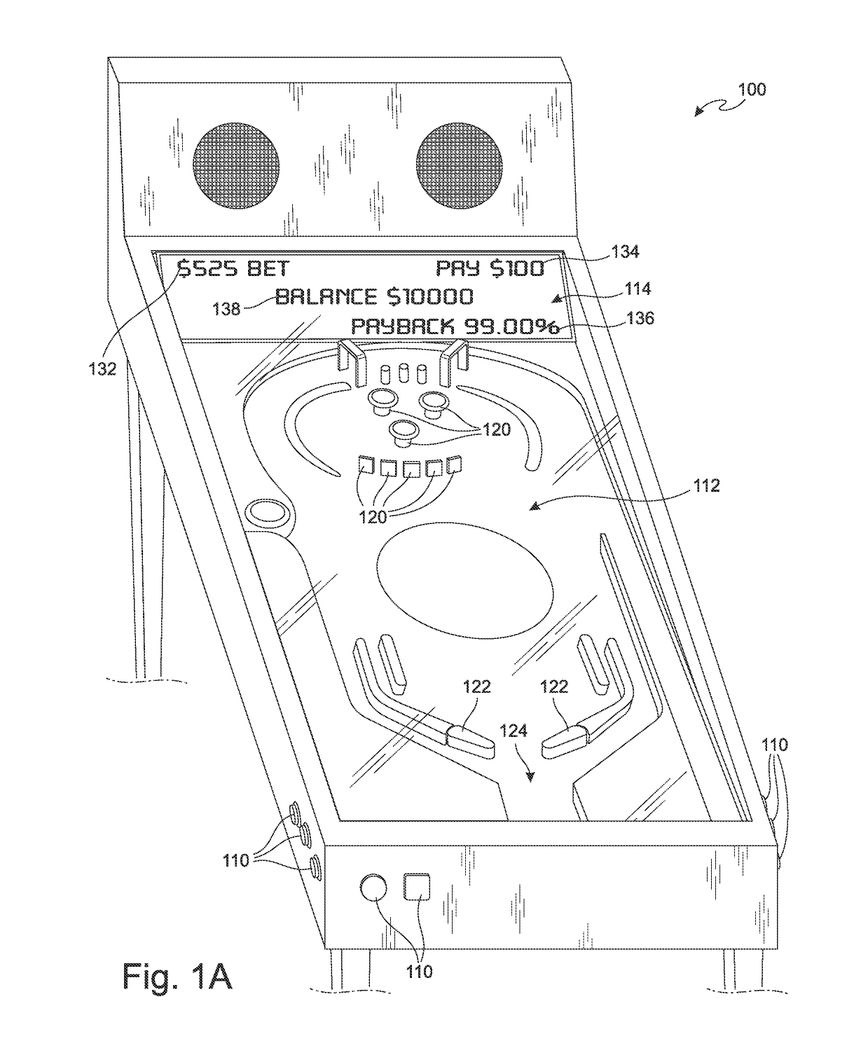

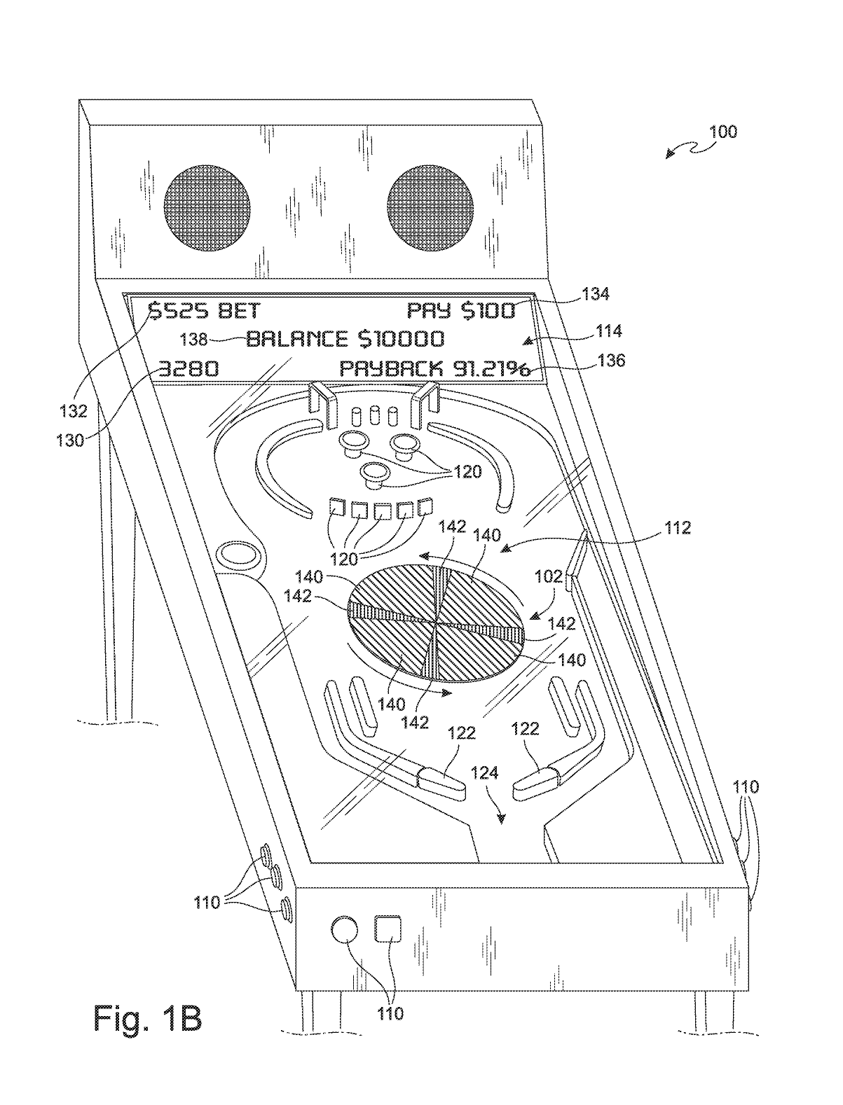

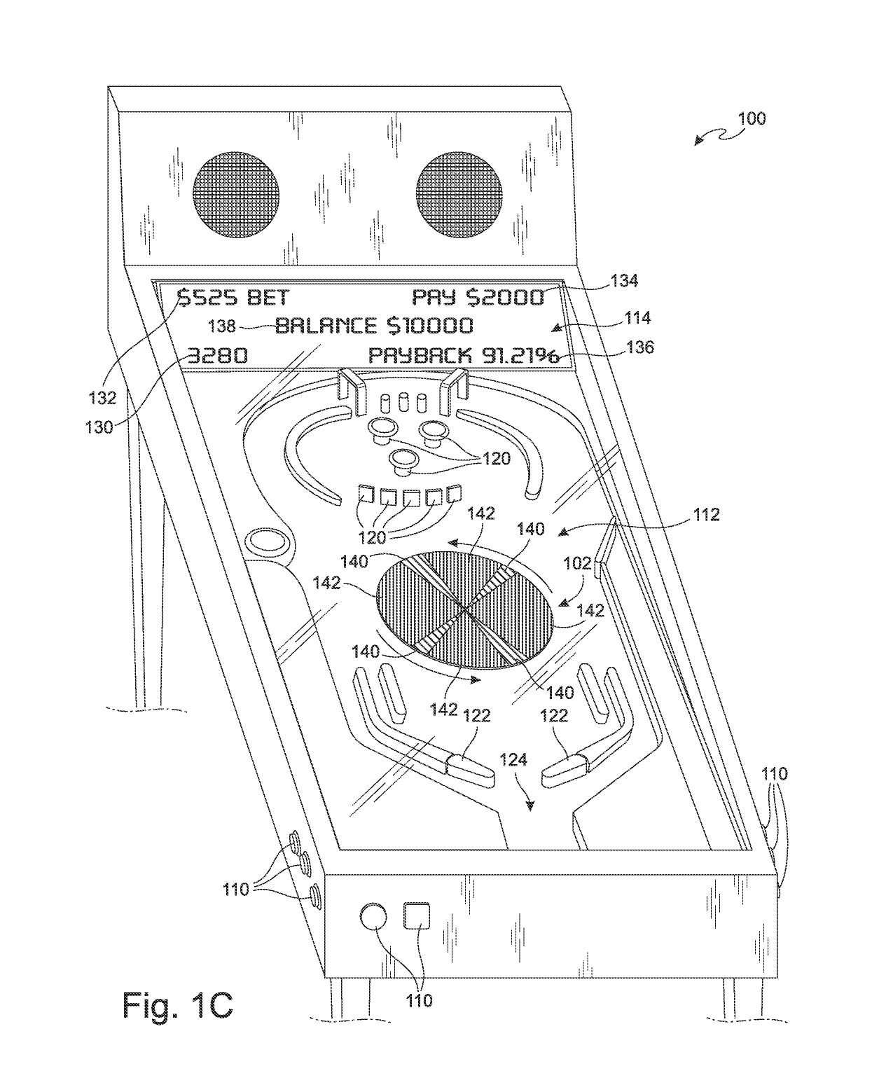

Referring to FIG. 1, the system of the present invention combines a game of skill with a game of chance to give a player the opportunity to improve the probability of winning the game of chance by performing well on the game of skill. Conversely, performing poorly on the game of skill could decrease the probability of winning the game of chance.

The game of skill typically includes games of the type that are found in arcades. In particular, the game of skill is one in which a comparison can be made as to how well a player has performed relative to past players. Typically, a game of skill involves the accumulation of points for achieving an objective. The points accumulate to make up the player's score 130. The score 130 at the end of the game can be compared to scores of past games to determine how the current score 130 ranks relative to past scores. Based on the relationship of the present score 130 compared to past scores, the probability of winning the game of chance can be altered. Therefore, the present system provides a player with an opportunity to gain a mathematical advantage in the game of chance through the game of skill.

Prior to beginning the game of skill, there may be a setup phase to allow the player to establish the parameters of the game of chance. By way of example only, the present invention is described herein as implemented in a pinball machine 100 as the game of skill and a spinning wheel as the game of chance.

The game of skill comprises one or more controllers 110, a playing field 112, and an information display 114. The game of chance comprises a random generator 102, here shown as the spinning wheel. The controller 110 allows the player to interact with the game by setting up the game, playing the game, and concluding the game. Typically controllers 110 may be buttons, joysticks, rollers, hand held devices, and the like. Controllers 110 may also include motion detectors to detect movement of the player.

The playing field 112 provides an area for playing the game of skill. The playing field 112 may be a physical board, field, court, and the like, or an electronic display of a board, field, court, and the like. In the example in FIGS. 1A-1C, the playing field 112 is electronically generated to mimic a physical pinball machine. As with typical pinball machines, the playing field 112 comprises a plurality of bumpers 120 and a pair of flippers 122. A ball is introduced into the playing field 112. As the ball impacts the bumpers 120, the bumpers 120 impart a force upon the ball to launch the ball in a different direction. Each time the ball impacts a bumper or enters into a scoring area, the player accumulates points as designated by the rules of the game. The playing field 112 is set up to cause the ball to fall towards an exit 124 to end the game. Flippers 122 are provided near the exit 124 to give the player the opportunity to keep the ball in play. The controllers 110 may also control the flippers 122 to keep the ball in play. The system can be implemented in any other typical arcade game such as shooting games, racing games, trivia games, simulator games, sports games, role playing games, and the like. In the preferred embodiment, the game of skill should last a few seconds to a few minutes.

As the player plays the game of skill, the player's score 130 may be displayed in real time on the information display 114. The information display 114 can be configured to display any information related to the game of skill or the game of chance. In the preferred embodiment, the information display 114 may show a bet amount 132, a win amount 134, an expected value 136, the player's balance 138, a score 130, and/or a score percentile, or any combination thereof.

During the setup phase prior to playing the game, the player can input an amount of money to play with, which is displayed as the balance 138. The player can then adjust the bet amount 132 based on the available balance 138. The bet amount 132 is the amount the player is willing to wager on the game of chance in hopes of winning more than what was bet with the risk of losing the bet amount 132 depending on the outcome of the game of chance. Using the controllers 110, the player can increase or decrease the bet amount 132.

Using the controllers 110, the player can toggle to the win amount 134, and enter or adjust the amount the player is hoping to win in the game of chance. The initial expected value is the expected rate of return before skill is factored in. The initial expected value may be based on the bet amount 132, wherein a machine may be set up to encourage players to bet higher amounts to attain better returns. A high bet amount 132 may lower the house edge, thus increasing the initial expected value. The initial probability of winning the game of chance may be based on the bet amount 132 and the win amount 134. If the player inputs a low bet amount 132 and a high win amount 134, the initial probability of winning would be low. Conversely, if the player inputs a high bet amount 132 and a low win amount 134, the initial probability of winning would be high for the game of chance.

In the preferred embodiment, the game of chance comprises a random generator 102. The random generator 102 generates win events and loss events. Depending on various factors, such as the bet amount 132, win amount 134, the score 130, score percentile, and the house edge, the random generator 102 can vary the probability of landing on a win event or a loss event. In the preferred embodiment, this probability is visually depicted during the setup phase while the player is determining the bet amount 132 and the win amount 134. By way of example only, as shown in FIG. 1B, the random generator 102 may be prominently displayed in the playing field 112. As the player enters the bet amount 132 and the win amount 134, the random generator visually depicts the initial probability of winning the win amount 134 based on the bet amount 132 and the house edge. In this example, the random generator 102 is depicted as a spinning wheel. The spinning wheel may have two colors. One color representing the win event 140 and the second color representing the loss event 142. By seeing the proportion of win events 140 compared to loss events 142, the player, without having to calculate the probabilities, can choose to change the bet amount 132 or the win amount 134. As the player chooses a different bet amount 132 and/or win amount 134, the proportion of win events 140 changes in real time relative to the proportion of loss events 142 so that the player can visually see his or her probability of winning the game of chance as shown in FIG. 1C. Preferably, the random generator 102 is displayed in the playing field 112, although the random generator can be displayed on the information display 114 or some other area.

Once the player has established the bet amount 132 and the win amount 134 and is satisfied with his or her initial probability of winning, the player can start the game of skill. The game of skill is played according the established rules for the game of skill. During the play, the player accumulates points and the score 130 is updated in real time. As the score 130 is updated, the score percentile is updated in real time. The score percentile compares the player's current score 130 with past scores for the game of skill and may display where the current score 130 ranks as compared to the past scores as a percentage. In some embodiments, the score percentile may be a function of all past scores on the game of skill. In some embodiments, if there are different difficulty levels, the score percentile may be a function of all past scores within the selected difficulty level being played. In some embodiments, the score percentile may be a function of all past scores for those who played with the same bet amount 132, the same win amount 134, or the same bet amount 132 and win amount 134. As the score 130 and score percentile are updated, the expected value 136 is also updated. Where the initial expected value displayed the average expected value based on an average score and the initial setup parameters (e.g. the bet amount 132, the win amount 134, house edge, etc.), the updated expected value further incorporates the score percentile to increase or decrease the initial estimate.

Once the game of skill comes to an end, the random generator is displayed to resolve the bet. However, the random generator is updated so that the number of win events and loss events reflects the updated probability of winning determined from the game of skill. In general, if the player had a score percentile of 50 percent, then the updated expected value would be the same as the initial expected value. If the player's score percentile was greater than 50 percent, then the updated expected value would be higher than the initial expected value. If the player's score percentile was lower than 50 percent, then the updated expected value would be lower than the initial expected value. Therefore, if the player plays well on the game of skill, he or she has the opportunity to gain a mathematical advantage in the game of chance.

In the preferred embodiment, the initial expected value (IEV) is calculated using the house edge (HE) by the formula IEV=100−HE, where the house edge is determined by the bet amount 132 initially input by the player and the house edge per bet amount initialized during setup. In the preferred embodiment, and typical casino pricing, the larger the bet amount 132, the higher the initial expected value.

In the preferred embodiment, the initial probability of winning (IPW) is calculated using the bet amount (BA) 132, win amount (WA) 134, and the house edge (HE), using the formula IPW=((BA)/(BA+WA))*((100−HE)/(100)). As previously stated, and before factoring the effect of the game of skill, the initial probability of winning the game of chance is based on the bet amount, win amount, and house edge.

In the preferred embodiment, the updated expected value (UEV) is calculated using the score 130 attained during the game of skill and, optionally, the skill factor input by the player before playing. The score 130 is compared with other scores in the score database to produce a score percentile (SP). In order to stay within the legal limits of modifying the expected value 136, such as Nevada setting a minimum slot machine payback of 75 percent, the skill component is multiplied by a skill alpha (SA). The skill alpha ensures that the modification to the initial expected value stays within the minimum and maximum boundaries of the expected value 136. The skill alpha may also reduce the effect of skill on the expected value 136 if the skill factor chosen by the player is low. Therefore, the house advantage (HA) is calculated by the formula HA=HE−100*SA*(SP−0.5), and the updated expected value is calculated by the formula UEV=100−HA. In the preferred embodiment, the updated probability of winning (UPW) is calculated using the formula UPW=((BA)/(BA+WA))*((100−HA)/100).

Additional safeguards may be implemented in such a system to ensure that players are unable to take advantage of a system. For example, a machine may be set up with a minimum theoretical hold percentage. At any moment in time, the sum total of payback for all wagers made on the game can never go below the minimum theoretical hold no matter how skilled or unskilled the players have been, and no matter how many or how few scores exist in the database. The system calculates the actual theoretical hold percentage, or the percentage expected to be held for the operation of the game so far, and compares this value to the minimum theoretical hold percentage desired by the operator. The difference between these values determines the total allowable theoretical advantage that may be given to players as a result of skill based play. The minimum theoretical hold percentage is not a constant, as the house edge varies based on the bet amount. Therefore when implementing this safeguard, the theoretical hold percentage must consider the bet amount, house edge per bet amount, score, and other related factors.

FIG. 4 shows a flow chart of an exemplary embodiment of the present invention. In this process, the machine or machines are set up by the machine owner at step 201. Initial configuration settings are set, such as those shown in step 202. These include the house edge per bet (HEPB), the score/bet database, and may also include a minimum/maximum bet, a minimum/maximum win amount, and other such settings. In preferred embodiments, the house edge per bet includes a table or sliding scale that decreases the house edge for higher bets. Additionally, these initial conditions may be governed by state law, such as a state law capping the house edge at a maximum. For example, for slot machines the house edge may be capped at a maximum of 25 percent. Once the game is initialized, the machine is set to prompt players for money in step 203 to begin playing.

When a player inputs money into the machine in step 204, a virtual wallet is updated in step 210 to keep track of how much the player has, i.e. his or her balance. Whenever the virtual wallet is updated, the virtual wallet is checked to determine how much money is in the wallet in step 211. If there is no money in the virtual wallet, the machine resumes prompting players to input money in step 203. In some embodiments, if the amount in the virtual wallet is below the minimum bet amount, the machine may also ask for money.

If there is sufficient money in the virtual wallet, the player may continue in step 220. The display may comprise options to play in step 221 or to cash out in step 222. Should the player decide to cash out in step 222, then the amount in the virtual wallet is output in step 223, the virtual wallet is zeroed in step 224, and the machine returns to prompting the player to input money in step 203. In some embodiments, the player is not shown the cash out option of step 222 unless the player has played at least one game. If the player decides to play the game in step 221, then the player continues to determine the player's betting conditions.

The player is given a choice in inputting a bet amount (BA), a win amount (WA), and a skill factor (SF) in step 230. In some embodiments, the skill factor may be set during the initialization step 201 and is not a player input. The machine determines the house edge (HE) based on the bet amount in step 232 and the house edge per bet (HEPB) in the initialized machine settings 202. The machine then determines the initial probability of winning (IPW) based on the formula: IPW=((BA)/(BA+WA))*((100−HE)/(100)) in step 233, and the initial expected value (IEV) based on the formula IEV=100−HE. At least one of the initial probability of winning and the initial expected value are displayed to the player. In some embodiments, this probability is displayed in number form. In other embodiments, this probability is displayed pictorially or graphically, for example, in the form of a chart, graph, or the like. The initial expected value may be shown to incentivize a player to increase the bet amount 132 in order to lower the house edge, which increases the initial expected value as determined by the house edge per bet. The player may continue to adjust betting parameters until satisfied, and then confirm the betting parameters in step 234 to move on to the game of skill.

While playing the game of skill, the player accumulates a score in step 240. As the score continually increases, the machine continually calculates several factors. The score is continually compared to a score database in step 241 in order to determine a score percentile (SP). A modifier, herein called the skill alpha (SA), is determined based on the skill factor input as a betting parameter. The higher the skill factor, the greater the range of the skill alpha. The skill alpha is bound by limits input during initialization of the machine. Ideally, these limits are the legal limits of the location of the machine, such as Nevada imposing a legal limit of a 25 percent house advantage (e.g. in slot machines). The score percentile is used to determine a new house advantage (HA) after skill is involved in step 242 based on the formula HA=HE−100*SA*(SP−0.5). When the house advantage is positive, the advantage belongs to the house. When the house advantage is negative, the advantage belongs to the player. Then the updated probability of winning (UPW) is calculated in step 243 based on the formula UPW=((BA)/(BA+WA))*((100−HA)/(100)). This is displayed to the user either during and/or after the game of skill. In some embodiments, the updated expected value (UEV) may also be determined, wherein the updated expected value is determined by the formula UEV=100−HA. In some embodiments, the UEV is continually displayed while the game of skill is in progress. When the game of skill concludes in step 244, the player moves on to the game of chance.

The game of chance uses the final updated probability of winning based on the score at the end of the game of skill. The probability of winning may be displayed, such as in the segmented wheel embodiment. The machine then generates a random number, for example, from 0 to 100, to determine if the player wins or loses in step 250. If the probability of winning is greater than the random number, the player wins. If the probability of winning is less than the random number, the player loses. In the pinball machine example, if an indicator lands on the win event 140, the player wins. If the indicator lands on a loss event 142, the player loses. Once these victory conditions are resolved, the score/bet database is updated in step 260 for the next game, and the virtual wallet is updated in step 210. If the player won, the win amount is added to the virtual wallet. If the player lost, the bet amount is deducted from the virtual wallet. The player may continue playing until the player runs out of money in the virtual wallet in step 211 or until the player cashes out in step 222.

In various embodiments, the method steps described herein, including the method steps described in FIG. 4, may be performed in an order different from the particular order described or shown. In other embodiments, other steps may be provided, or steps may be eliminated, from the described methods.

The present invention may also be implemented in arcade games with the resolution of the game of chance resulting in winning tokens, tickets, credits, and the like. The tokens, tickets, credits, and the like can be redeemed to play additional games or purchase prizes.

Systems, apparatus, and methods described herein may be implemented using digital circuitry, or using one or more computers using well known computer processors, memory units, storage devices, computer software, and other components. Typically, a computer includes a processor for executing instructions and one or more memories for storing instructions and data. A computer may also include, or be coupled to, one or more storage devices, such as one or more magnetic disks, internal hard disks and removable disks, optical disks, etc.

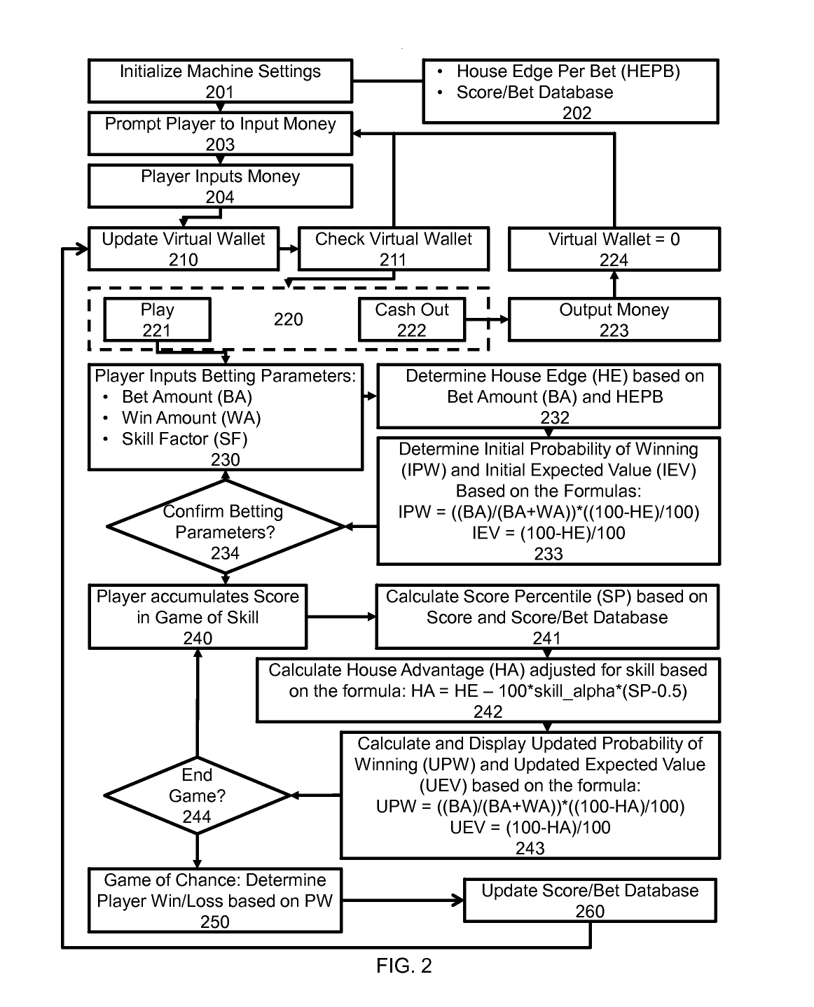

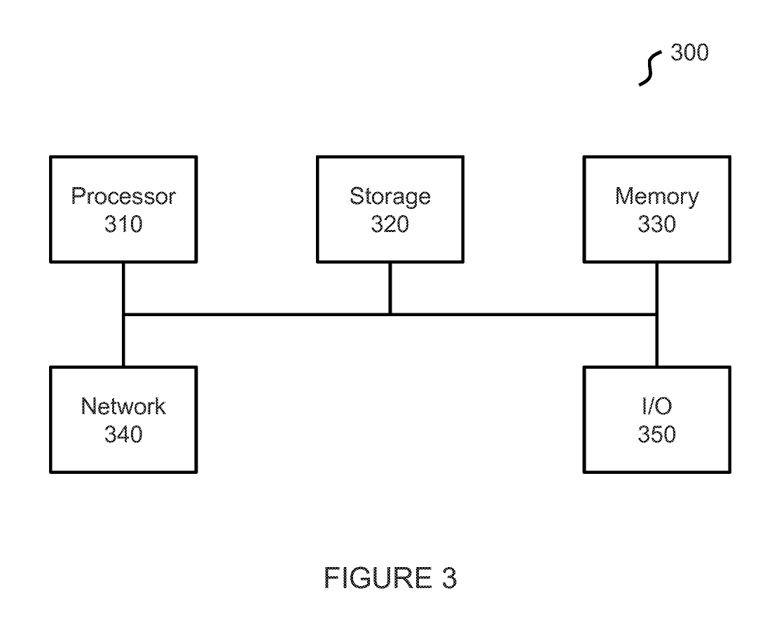

A high-level block diagram of an exemplary computer 300 that may be used to implement systems, apparatus, and methods described herein is illustrated in FIG. 3. The computer 300 comprises a processor 310 operatively coupled to a data storage device 320 and memory 330. Processor 310 controls the overall operation of computer 300 by executing computer program instructions that define such operations. The computer program instructions may be stored in data storage device 320, or other non-transitory computer readable medium, and loaded into memory 330 when execution of the computer program instructions is desired. Thus, the method steps of FIG. 2 can be defined by the computer program instructions stored in memory 330 and/or data storage device 320 and controlled by processor 310 executing the computer program instructions.

For example, the computer program instructions can be implemented as computer executable code programmed by one skilled in the art to perform an algorithm defined by the method steps in FIG. 2. Computer 300 may also include one or more network interfaces 340 for communicating with other devices via a network. Computer 300 also includes one or more input/output devices 350 that enable user interaction with computer 300 (e.g., display, keyboard, touchpad, mouse, speakers, buttons, etc.).

Processor 310 can include, among others, special purpose processors with software instructions incorporated in the processor design with instructions in storage device 320 or memory 330, to control the processor 310, and may be the sole processor or one of multiple processors of computer 300. Processor 310 may be a self-contained computing system, containing multiple cores or processors, a bus, memory controller, cache, etc. A multi-core processor may be symmetric or asymmetric. Processor 310, data storage device 320, and/or memory 330 may include, be supplemented by, or incorporated in, one or more application-specific integrated circuits (ASICs) and/or one or more field programmable gate arrays (FPGAs). It can be appreciated that the disclosure may operate on a computer 300 with one or more processors 310.

Data storage device 320 and memory 330 each comprise a tangible non-transitory computer readable storage medium. By way of example, and not limitation, such non-transitory computer-readable storage medium can include random access memory (RAM), high-speed random access memory (DRAM), static random access memory (SRAM), double data rate synchronous dynamic random access memory (DDRRAM), read-only memory (ROM), erasable programmable read-only memory (EPROM), electrically erasable programmable read-only memory (EEPROM), flash memory, compact disc read-only memory (CD-ROM), digital versatile disc read-only memory (DVD-ROM) disks, or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

In some embodiments the computer 300 may comprise a network/communication interface 340. Network/communication interface 340 enables the computer 300 to communicate with networks, such as the Internet, also referred to as the World Wide Web (WWW), an intranet and/or a wireless network, such as a cellular telephone network, a wireless local area network (LAN) and/or a metropolitan area network (MAN), and other devices using any suitable communications standards, protocols, and technologies. By way of example, and not limitation, such suitable communications standards, protocols, and technologies can include Ethernet, Wi-Fi (e.g., IEEE 802.11), Wi-MAX (e.g., 802.16), Bluetooth, near field communications (“NFC”), radio frequency systems, infrared, GSM, EDGE, HS-DPA, CDMA, TDMA, quadband, VoIP, IMAP, POP, XMPP, SIMPLE, IMPS, SMS, or any other suitable communications protocols. By way of example, and not limitation, the network interface 340 enables the computer 300 to transfer data, synchronize information, update software, or any other suitable operation.

Input/output devices 350 may include peripherals, such as a printer, scanner, monitor, etc. Input/output devices 350 may also include parts of a computing device, such as a touchscreen, speakers, and buttons. For example, input/output devices 350 may include a display device such as a liquid crystal display (LCD) monitor for displaying information to the user, such as the information display 114, and input devices, such as the controllers 110, by which the user can provide input to the computer 300, or a touchscreen for both input and output.

One skilled in the art will recognize that an implementation of an actual computer or computer system may have other structures and may contain other components as well, and that FIG. 3 is a high level representation of some of the components of such a computer for illustrative purposes.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A method of providing an opportunity to gain a mathematical advantage in a game of chance through a game of skill, comprising:
a. providing a playing field for playing the game of skill;
b. providing a random generator for playing the game of chance displayable within the playing field;
c. providing an information display capable of displaying:
i. a bet amount (BA),
ii. a win amount (WA),
iii. an initial expected value (IEV),
iv. a score, and
v. a score percentile (SP);
d. providing one or more controllers for setting the bet amount and the win amount during a setup phase and for playing the game of skill during a play phase;
e. while the bet amount and the win amount is being set, displaying the random generator to visually depict an initial probability of winning, the visual depiction of the initial probability of winning adjusting in real time as the payment amount and the bet amount changes;
f. while the game of skill is being played, updating in real time:
i. the score based on rules of the game of skill,
ii. the score percentile based on past scores,
iii. a house advantage (HA), and
iv. an updated expected value (UEV), which factors in a house edge (HE) and the score percentile, wherein if the score percentile is below 50 percent, the updated expected value is lower than the initial expected value, wherein if the score percentile is 50 percent the updated expected value equals the initial expected value, and wherein if the score percentile is greater than 50 percent the updated expected value increases relative to the initial expected value;
g. when the game of skill ends,
i. calculating an updated probability of winning (UPW), and
ii. starting the game of chance, wherein the game of chance is resolved based on the updated probability of winning;
h. wherein the house edge is based on the bet amount, wherein changing the bet amount may change the house edge;
i. wherein the initial expected value is calculated by IEV=(100−HE)/100;
j. wherein the house advantage is calculated by HA=HE−[(100)*(skill alpha)*(SP−0.5)], wherein skill alpha is a modifier that limits a range of values of the updated expected value;
k. wherein the updated expected value is calculated by the formula UEV=(100−HA)/100,
l. wherein the updated probability of winning is calculated by UPW=[(BA)/(BA+WA)]*[(100−HA)/100];
m. whereby a player may gain the mathematical advantage by playing the game of skill if the player is able to score better than an average score.

2. A method of providing an opportunity to gain a mathematical advantage in a game of chance through a game of skill, comprising:
a. providing a playing field for playing the game of skill;
b. providing a random generator for playing the game of chance displayable within the playing field;
c. providing an information display, capable of displaying:
i. a bet amount (BA),
ii. a win amount (WA),
iii. an initial expected value (IEV),
iv. a score, and
v. a score percentile (SP);
d. providing one or more controllers for setting the bet amount and the win amount during a setup phase and for playing the game of skill during a play phase;
e. while the bet amount and the win amount is being set, calculating
i. an initial probability of winning (IPW), and
ii. an initial expected value (IEV);
f. while the game of skill is being played, updating in real time
i. the score based on rules of the game of skill,
ii. the score percentile based on past scores,
iii. a house advantage (HA),
iv. an updated expected value (UEV), which accounts for a house edge (HE) and factors in the score percentile, and
v. an updated probability of winning (UPW); and
g. when the game of skill ends, starting the game of chance, wherein the game of chance is resolved based on the updated probability of winning determined during the game of skill.

3. The method of claim 2, wherein the initial expected value is calculated by IEV=(100−HE)/100.

4. The method of claim 3, wherein the house edge is based on the bet amount, whereby a large bet amount will decrease the house edge, which increases the initial expected value.

5. The method of claim 4, wherein the house edge is an amount bound between 0.1 and 25.

6. The method of claim 2, wherein the house advantage is calculated based on HA=HE−[(100)*(skill alpha)*(SP−0.5)], wherein skill alpha is a modifier that limits the range of values of the updated expected value.

7. The method of claim 6, wherein the updated expected value is calculated by the formula UEV=(100−HA)/100.

8. The method of claim 7, wherein the updated probability of winning is calculated by UPW=((BA)/(BA+WA))*(UEV).

9. The method of claim 8, wherein the game of chance is played within the playing field of the game of skill after the game of skill has ended.

10. The method of claim 8, wherein the initial probability of winning updates and is displayed in real time as the payment amount and the bet amount changes.

11. The method of claim 8, wherein the initial expected value updates and is displayed in real time as the bet amount changes.

12. A combination game of skill and game of chance, comprising:
a. a game of skill;
b. a game of chance, wherein the game of chance is resolved after the game of skill, and wherein the game of skill provides an opportunity for gaining a mathematical advantage for winning the game of chance; and
c. a computing device one or more processors, a memory; and one or more programs, wherein the one or more programs are stored in the memory and configured to be executed by the one or more processors, the one or more programs including instructions to calculate the mathematical advantage for winning the game of chance based on a score from the game of skill.

13. The combination game of skill and game of chance of claim 12, wherein the mathematical advantage for winning the game of chance is based on a score percentile (SP) determined during the game of skill.

14. The combination game of skill and game of chance of claim 13, wherein the score percentile is determined by comparing the score with past scores recorded on the game of skill.

15. The combination game of skill and game of chance of claim 14, wherein the mathematical advantage for winning the game of chance accounts for a house advantage (HA), the house advantage calculated by HA=a house edge−[(100)*(skill alpha)*(SP−0.5)], wherein skill alpha is a modifier that limits a range of values of an updated expected value (UEV).

16. The combination game of skill and game of chance of claim 15, wherein the updated expected value (UEV) is calculated by UEV=(100−HA)/100.

17. The combination game of skill and game of chance of claim 16, wherein the game of chance is resolved based on an updated probability of winning (UPW) calculated by UPW=((a bet amount)/(the bet amount+a win amount)*(UEV).

18. The combination game of skill and game of chance of claim 17, wherein an initial probability of winning is updated and displayed in real time as the win amount and the bet amount is entered and prior to the game of skill being played.

19. The combination game of skill and game of chance of claim 17, wherein an initial expected value is updated and displayed in real time as the bet amount is entered and prior to the game of skill being played.
